(19) United States
(12) Patent Application Publication
(10) Pub. No.: US 2024/0255663 A1
(43) Pub. Date: Aug. 1, 2024

(54) STANDARDIZED REMOTE DETERMINATION SYSTEM AND METHOD OF SEISMIC SENSOR ORIENTATION USING EARTHQUAKE WAVEFORMS AND MICROSEISM RECORDS

(71) Applicant: UIF (University Industry Foundation), Yonsei University, Seoul (KR)

(72) Inventors: Tae-Kyung HONG, Goyang-si (KR); Seongjun PARK, Seoul (KR)

(21) Appl. No.: 18/397,970

(22) Filed: Dec. 27, 2023

(30) Foreign Application Priority Data
Jan. 27, 2023 (KR) 10-2023-0010539

(51) Int. Cl. G01V 1/28; G01V 1/01

(52) U.S. Cl. CPC G01V 1/288; G01V 1/01; G01V 2210/1232; G01V 2210/65

(57) ABSTRACT

A remote determination system of seismic sensor orientation comprises: a data collection unit that receives earthquake waveforms and microseism records; a data analysis unit that analyzes earthquake P-waves and earthquake Rayleigh-waves of the earthquake waveforms and analyzes microseism of the input microseism records; a reference seismic sensor selection unit that selects a reference seismic sensor using analysis results derived from the data analysis unit; a misorientation angle determination unit that determines a misorientation angle of a target seismic sensor, using an apparent radial direction determined through microseism analysis and the reference seismic sensor; and a final representative value determination unit that determines a final representative value of a seismic sensor orientation, by collecting a seismic sensor orientation estimate from the earthquake P-wave analysis, a seismic sensor orientation estimate from the earthquake Rayleigh-wave analysis, and a seismic sensor misorientation angle determination value from the misorientation angle determination unit.

### CROSS-REFERENCE TO RELATED APPLICATIONS

This application claims priority under 35 U.S.C. § 119(a) to Korean Patent Application No. 10-2023-0010539, filed on Jan. 27, 2023, with the Korean Intellectual Property Office, the disclosure of which is incorporated herein in its entirety by reference.

### BACKGROUND

### 1. Technical Field

The present disclosure relates to a standardized remote determination system and method of seismic sensor orientation, and more particularly to a standardized remote determination system and method of seismic sensor orientation using earthquake waveforms and microseism records.

### 2. Description of the Related Art

First, terms involved in the present disclosure are described as follows.

A seismometer is an instrument that records the movement of the ground, and a three-component sensor (e.g., east-west, south-north, up-down) is required to fully record spatial movement. Generally, the orientation of the seismic sensor is set based on the due north direction measured using a compass. Depending on the type of installation, there are surface seismometers and borehole seismometers. In the case of borehole seismometers, it is particularly difficult to install the seismometer correctly in the set direction.

Earthquake refers to sudden movement of the ground (mainly fault movement) and the shaking of the ground that occurs as a result. The stronger it is, the more it causes the ground to vibrate, and these ground motions (seismic motions) are recorded on a seismometer.

Ambient seismic noise refers to a background level of ground shaking caused by various natural/artificial phenomena and activities (e.g., waves, wind, weather activities, cars, airplanes, human footsteps, etc.) other than earthquakes (or including small earthquakes that cannot be specified).

Microseism refers to energy that appears clearly below 1 Hz in seismic noise, and is known to be mainly caused by ocean activity. It is largely divided into primary microseism, which appears between ˜0.05-0.1 Hz, and secondary microseism, which appears at the ˜0.1-0.5 Hz frequency band.

P wave is one of the forms of seismic waves and vibrates in a direction parallel to the direction of travel.

Rayleigh wave is one of the forms of seismic waves and travels horizontally along the surface, showing retrograde elliptical motion.

A seismometer is a device that records the shaking of the ground. Seismic wave data (seismogram) recorded by a seismometer is used to observe a subterranean structure and properties, and various activities within the earth that involve dynamic movement of the ground. From an academic perspective, these data are one of the most important basic data in geology and seismology, and in addition to academic purposes, they are also used for regular observation and early warning of seismic activity, site surveys for construction, etc. Depending on the type of installation, these seismometers can be divided into surface seismometers installed on the surface and borehole seismometers installed below the surface through boreholes.

To record three-dimensional ground movement, seismic motion sensors typically record three components of movement in the north-south, east-west, and up-down directions. For correct recording and analysis of seismic motion, it is important to install the seismic motion sensor in the correct direction.

Traditionally, a seismometer can be installed correctly by orienting the north-south sensor toward due north as measured based on a compass. In the case of a surface seismometer installed on the earth surface, the seismometer can be installed while visually checking the direction of the seismometer, making it easy to place the seismometer in the correct direction.

On the other hand, in the case of borehole seismometers, it is difficult to install the seismometer in the intended direction due to the nature of the installation process. Therefore, in the case of borehole seismometers, there is a high possibility that the seismometer will be placed in a direction that deviates from the correct direction (i.e., due north and due east direction).

Meanwhile, if the due north direction is measured incorrectly due to factors such as local magnetic fields, there is a possibility that the surface seismometer, which is easy to set direction, may also be installed in the wrong direction. Therefore, for accurate analysis of seismic motion data, it is desirable to precisely measure the direction in which the seismometer is located and take the process of correcting this when analyzing the data.

Various methodologies have been proposed in the past to measure the orientation of a seismometer.

One of the traditional methods is to utilize the ‘seismic signal’ generated when an earthquake occurs. Seismic waves propagate while vibrating in a specific direction, which is called polarization.

In particular, in the case of P waves and Rayleigh waves, the horizontal component of the vibration direction (lateral polarization direction) is horizontal to the direction of seismic wave propagation, so the propagation direction of the seismic wave, that is, the radial direction, can be determined from the vibration direction of the seismic motion.

When the seismometer is positioned correctly, this radial direction appears parallel to the theoretical radial direction for the path from the earthquake to a station. On the other hand, if the seismometer is deviated from the correct direction, the theoretical radial direction and the observed apparent radial direction differ by that angle, and by measuring this, the angle at which the seismometer is deviated can be estimated.

This method has been commonly used to measure the orientation of a seismometer, but it has the problem of having to wait for an earthquake that is easy to analyze to occur in order to stably measure the orientation of the seismometer, and also has the problem of requiring a large amount of earthquake waveforms to be accumulated over a long period of time.

Therefore, the above-described method has had difficulty in quickly estimating the orientation of the seismometer. In addition, if there are errors and limitations in the information used to calculate the theoretical radial direction, such as the location of the earthquake and the characteristics of the medium, there is a limitation that these factors may cause errors in the final estimate of the orientation of the seismometer.

Meanwhile, as another conventional method, a method of estimating the orientation of a seismometer has been proposed using microseism, a type of background noise (ambient noise) that always exists, instead of an earthquake, which is a temporary phenomenon.

Microseism is seismic wave energy generated when pressure perturbations caused by ocean waves stimulate the ocean floor. Microseism is an energy that exists almost all the time, and the advantage of using it is that there is no need to wait a long time for a specific signal to occur, as is the case when using earthquake waveforms, so continuous analysis and determination of the orientation of the seismometer are possible.

Microseism contains the energy of Rayleigh wave components, and their direction of travel can be estimated through polarization analysis of these Rayleigh waves. Microseisms originating at a distance form plane waves in a local area. In other words, the radial directions of Rayleigh waves within microseisms that appear in a local area are all horizontal. Therefore, the actual radial direction of Rayleigh waves within the microseisms is expected to be horizontal in all seismometers of the local area.

On the other hand, the apparent radial direction shown in seismometer records may deviate from the actual radial direction depending on the orientation in which the seismometer is installed. Therefore, as in the analysis of earthquakes, the difference between the actual radial direction of Rayleigh waves within the microseisms and the apparent radial direction indicates the orientation in which the seismometer is installed.

If there is a seismometer with a known orientation in the area, the actual radial direction can be estimated by correcting the apparent radial direction observed at that seismometer. The orientation of each seismometer can be estimated by comparing the estimated actual radial direction with the apparent radial direction observed at each seismometer.

Because this method uses always-present microseism energy, it does not require waiting for a specific signal to occur for a long period of time, and thus has the advantage of being applicable on a regular basis. In addition, by utilizing the actually observed radial direction of seismic waves, there is an advantage of being free from analysis errors resulting from seismic source location errors and media effects.

On the other hand, this method requires a seismometer with a known installed orientation to determine the reference radial direction in the area. Therefore, there is a limitation that it is difficult to apply when there is no orientation information for seismometers in the area.

As such, each of the conventional methods has its own advantages and disadvantages, so for more accurate orientation estimation, it is necessary to utilize the advantages of various methods to complement each other.

Accordingly, the present disclosure seeks to propose a new normalized process for accurate seismometer orientation estimation by combining conventional methods.

### SUMMARY OF THE INVENTION

A standardized remote determination system and method of seismic sensor orientation using earthquake waveforms and microseism records according to the present disclosure have the following objects:
First, the present disclosure intends to estimate the immediate seismic sensor orientation.
Second, the present disclosure intends to estimate the seismic sensor orientation with high accuracy.
Third, the present disclosure intends to normalize the estimation process of seismometer orientation.

The objects of the present disclosure are not limited to the above-described objects, and other objects that have not been described above will be clearly understood by those of ordinary skill in the art to which the present disclosure pertains from the following description.

According to an aspect of the present disclosure, there is provided a standardized remote determination system of seismic sensor orientation, performed by a control server with database and operation functions, the system comprising: a data collection unit that receives earthquake waveforms and microseism records; a data analysis unit that analyzes earthquake P-waves and earthquake Rayleigh-waves of the earthquake waveforms input to the data collection unit and analyzes microseism of the input microseism records; a reference seismic sensor selection unit that selects a reference seismic sensor using analysis results derived from the data analysis unit; a misorientation angle determination unit that determines a misorientation angle of a target seismic sensor, using an apparent radial direction determined through microseism analysis in the data analysis unit and the reference seismic sensor selected in the reference seismic sensor selection unit; and a final representative value determination unit that determines a final representative value of a seismic sensor orientation, by collecting a seismic sensor orientation estimate calculated from the earthquake P-wave analysis of the data analysis unit, a seismic sensor orientation estimate calculated from the earthquake Rayleigh-wave analysis, and a seismic sensor misorientation angle determination value calculated from the misorientation angle determination unit.

In an embodiment, the data collection unit may collect three-component earthquake waveforms recorded in each seismic sensor for seismic wave analysis, and collect three-component continuous waveform data recorded in each seismic sensor for microseism analysis.

In an embodiment, the data analysis unit may include an earthquake P-wave analysis unit that performs polarization analysis on earthquake P-waves and estimates the seismic sensor orientation, an earthquake Rayleigh-wave analysis unit that performs polarization analysis on earthquake Rayleigh-waves and estimates the seismic sensor orientation, and a microseism analysis unit that performs polarization analysis on Rayleigh-waves included in microseism and determines the apparent direction of the seismic sensor.

In an embodiment, the reference seismic sensor selection unit may select, as a reference seismic sensor, a seismic sensor whose reliability for an estimate meets a preset standard, among seismic sensors whose misorientation angles have previously been determined.

In an embodiment, the preset reliability standard of the reference seismic sensor selection unit may include at least one standard of a first standard where an error between the seismic sensor misorientation angles determined through mutually independent analysis is less than a preset angle, or a second standard where the standard error for the estimate is below a preset level.

In an embodiment, when multiple misorientation angles are presented in one reference seismic sensor, the reference seismic sensor selection unit may select the misorientation angle of the one reference seismic sensor using any one of a first decision method for determining the arithmetic mean value of the presented seismic sensor misorientation angles as a representative misorientation angle, a second decision method for determining the weighted average value of the presented seismic sensor misorientation angles as a representative misorientation angle, a third decision method for determining the median value of the presented seismic sensor misorientation angles as a representative misorientation angle, or a fourth decision method for determining a representative misorientation angle among the presented seismic sensor misorientation angles according to preset priorities.

In an embodiment, the misorientation angle determination unit may include a reference radial direction determination unit that determines the reference radial direction by correcting the seismic sensor misorientation angle from the apparent Rayleigh-wave radial direction observed in the reference seismic sensor, and a misorientation angle estimation unit that estimates the misorientation angle of the target seismic sensor by comparing the apparent Rayleigh-wave radial direction observed in the target seismic sensor with the reference Rayleigh-wave radial direction observed in the reference seismic sensor at the same location.

In an embodiment, the misorientation angle estimation unit can estimate the misorientation angle through Equation 9 below:

$${φ}_{M} = {θ}_{M} - {θ}_{M}^{′} \qquad [ Equation 9 ]$$

where θ_{M} is the reference Rayleigh wave radial direction, and θ′_{M} is the apparent Rayleigh wave radial direction at the target seismic sensor.

In an embodiment, the final representative value determination unit may select the final representative value using any one of a first decision method for determining the arithmetic mean value of the three calculated seismic sensor misorientation angles as the final representative value, a second decision method for determining the weighted average value of the three calculated seismic sensor misorientation angles as the final representative value, a third decision method for determining the median value of the three calculated seismic sensor misorientation angles as the final representative value, or a fourth decision method for determining the final representative value among the three calculated seismic sensor misorientation angles, according to preset priorities.

According to another aspect of the present disclosure, there is provided a standardized remote determination method of seismic sensor orientation, performed by a control server with database and operation functions, the control server performing the steps of a step S100 in which a data collection unit receives earthquake waveforms and microseism records; a step S200 in which a data analysis unit analyzes earthquake P-waves and earthquake Rayleigh-waves of the earthquake waveforms input to the data collection unit, and analyzes microseism of the input microseism records; a step S300 in which a reference seismic sensor selection unit selects a reference seismic sensor using analysis results derived from the data analysis unit; a step S400 in which a misorientation angle determination unit determines a misorientation angle of a target seismic sensor, using an apparent radial direction determined through microseism analysis in the data analysis unit and the reference seismic sensor selected in the reference seismic sensor selection unit; and a step S500 in which a final representative value determination unit determines a final representative value of a seismic sensor orientation, by collecting a seismic sensor orientation estimate calculated from the earthquake P-wave analysis of the data analysis unit, a seismic sensor orientation estimate calculated from the earthquake Rayleigh-wave analysis, and a seismic sensor misorientation angle determination value calculated from the misorientation angle determination unit.

In an embodiment, the step S200 may include: a step S210 in which an earthquake P-wave analysis unit performs polarization analysis on earthquake P-wave and estimates the seismic sensor orientation, a step S220 in which an earthquake Rayleigh-wave analysis unit performs polarization analysis on earthquake Rayleigh-waves and estimates the seismic sensor orientation, and a step S230 in which a microseism analysis unit performs polarization analysis on Rayleigh-waves included in microseism and determines the apparent orientation of the seismic sensor.

In an embodiment, in the step S300, a seismic sensor whose reliability for an estimate meets a preset standard, among seismic sensors whose misorientation angles have previously been determined, may be selected as a reference seismic sensor.

In an embodiment, the step S400 may include: a step S410 in which a reference radial direction determination unit determines the reference radial direction by correcting the seismic sensor misorientation angle from the apparent Rayleigh-wave radial direction observed in the reference seismic sensor, and a step S420 in which a misorientation angle estimation unit estimates the misorientation angle of the target seismic sensor by comparing the apparent Rayleigh-wave radial direction observed in the target seismic sensor with the reference Rayleigh-wave radial direction observed in the reference seismic sensor at the same location.

In an embodiment, in the step S500, the final representative value may be selected using any of a first decision method for determining the arithmetic mean value of the three calculated seismic sensor misorientation angles as the final representative value, a second decision method for determining the weighted average value of the three calculated seismic sensor misorientation angles as the final representative value, a third decision method for determining the median value of the three calculated seismic sensor misorientation angles as the final representative value, or a fourth decision method for determining the final representative value among the three calculated seismic sensor misorientation angles, according to preset priorities.

The present disclosure may be implemented as a computer program stored in a computer-readable storage medium in order to execute the standardized remote determination method of seismic sensor orientation using earthquake waveforms and microseism records according to the present disclosure in conjunction with hardware by a computer.

The standardized remote determination system and method of seismic sensor orientation using earthquake waveforms and microseism records according to the present disclosure have the following effects:
First, the present disclosure provides the effect of immediately estimating the seismic sensor orientation after installing the seismometer.
Second, the present disclosure provides the effect of improving the accuracy and reliability of future earthquake record analysis, by estimating the seismic sensor orientation with high accuracy.
Third, the present disclosure provides the effect of quickly and uniformly determining the seismic sensor orientation, by normalizing the seismic sensor orientation estimation process.

The effects of the present disclosure are not limited to the above-described effects, and other effects that have not been described above will be clearly understood by those of ordinary skill in the art to which the present disclosure pertains from the foregoing description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of earthquake wave propagation and apparent radial direction in a seismic sensor.

FIG. 2 is a schematic diagram of the energy propagation of microseism and seismic sensor records in a local area.

FIG. 3 shows the distribution of seismic sensors on the Korean Peninsula.

FIG. 4 shows a mesoscale earthquake map.

FIG. 5 shows an example of earthquake P-wave waveforms.

FIG. 6 shows an example of earthquake P-wave polarization analysis.

FIG. 7 shows the seismic sensor misorientation angle estimated by earthquake P-wave analysis.

FIG. 8 shows an example of earthquake Rayleigh-wave waveforms.

FIG. 9 shows an example of earthquake Rayleigh-wave polarization analysis.

FIG. 10 shows the seismic sensor misorientation angle estimated by earthquake Rayleigh-wave analysis.

FIG. 11 shows an example of a continuous waveform spectrogram.

FIG. 12 shows data from the station KH2B broadband seismic sensor, as an example of microseism polarization analysis.

FIG. 13 shows data from the station KH2B accelerometer, as an example of microseism polarization analysis.

FIG. 14 shows the seismic sensor misorientation angle estimated by microseism analysis.

FIG. 15 shows data from the station CHC2 broadband seismic sensor, as an example of a comparison of seismic sensor misorientation angle estimates.

FIG. 16 shows data from the station EUSB broadband seismic sensor, as an example of a comparison of seismic sensor misorientation angle estimates.

FIG. 17 shows data from the station KWJU broadband seismic sensor, as an example of a comparison of seismic sensor misorientation angle estimates.

FIG. 18 shows a configuration diagram of a remote determination system of seismic sensor orientation according to the present disclosure.

FIG. 19 shows a flowchart of a remote determination method of seismic sensor orientation according to the present disclosure.

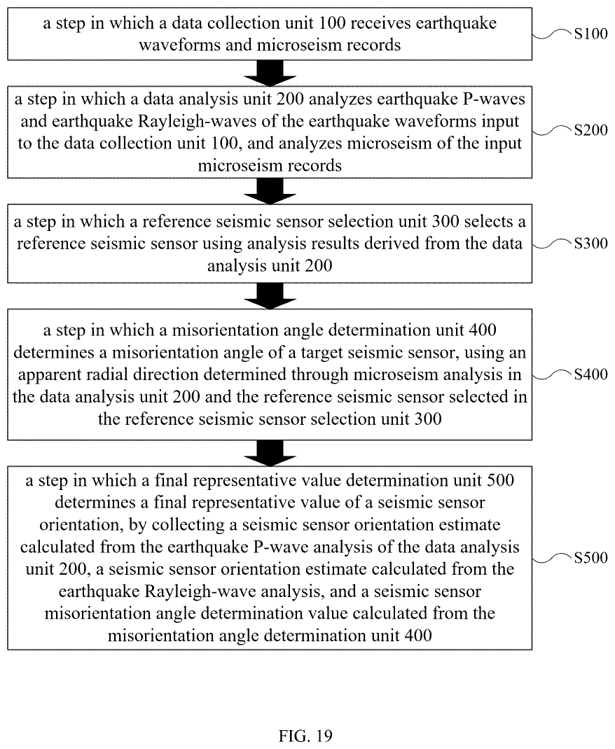

### DETAILED DESCRIPTION OF THE INVENTION

Embodiments of the present disclosure will be described with reference to the accompanying drawings below so that those of ordinary skill in the art to which the present disclosure pertains can easily implement the present disclosure. As can be easily understood by those of ordinary skill in the art to which the present disclosure pertains, embodiments to be described below may be modified in various forms without departing from the spirit and scope of the present disclosure. Wherever possible, the same reference numbers will be used throughout the drawings to refer to the same or like parts.

The terminology used herein is intended merely to illustrate specific embodiments, and is not intended to limit the present disclosure. As used herein, the singular forms “a,” “an,” and “the” are intended to include the plural forms as well, unless the context clearly indicates otherwise.

The terms “include,” “comprise,” “including,” and “comprising,” and their derivatives specify the presence of one or more described features, regions, integers, steps, operations, elements, parts and/or components, and do not preclude the presence or addition of one or more other features, regions, integers, steps, operations, elements, parts, components, and/or groups thereof.

All terms including technical or scientific terms used herein have the same meanings as commonly understood by those of ordinary skill in the art to which the present disclosure pertains. It will be further understood that terms, such as those defined in commonly used dictionaries, should be interpreted as having meanings that are consistent with their meanings in the context of the specification and relevant art and should not be interpreted in an idealized or overly formal sense unless expressly so defined herein.

Directional expressions used in this specification, for example, front/back/left/right expressions, up/down expressions, longitudinal/transverse direction expressions may be interpreted with reference to the directions disclosed in the drawings.

Hereinafter, in order to contrast with the features of the present disclosure, a ground motion analysis and seismometer orientation estimation method according to the prior art will be described in more detail.

In the prior art, a ground motion generated from an earthquake and recorded in a seismometer is analyzed, the direction of the vibration is analyzed, and the orientation of the seismometer is estimated through this.

By the angle (misorientation angle) at which the seismometer sensor is deviated from the correct direction (i.e., due north), the apparent radial direction derived from seismometer records deviates from the actual radial direction.

For this analysis, P waves or Rayleigh waves are used, and the lateral components of the vibrations of P waves and Rayleigh waves are parallel to the radial direction, which is the direction in which seismic waves travel. In other words, it is expected to be parallel to the great-circle path from the earthquake to the seismometer, which is the path along which seismic waves travel. Therefore, the difference in angle between the apparent radial direction and the great-circular path direction indicates the angle (misorientation angle) by which the seismometer is oriented away from the correct direction.

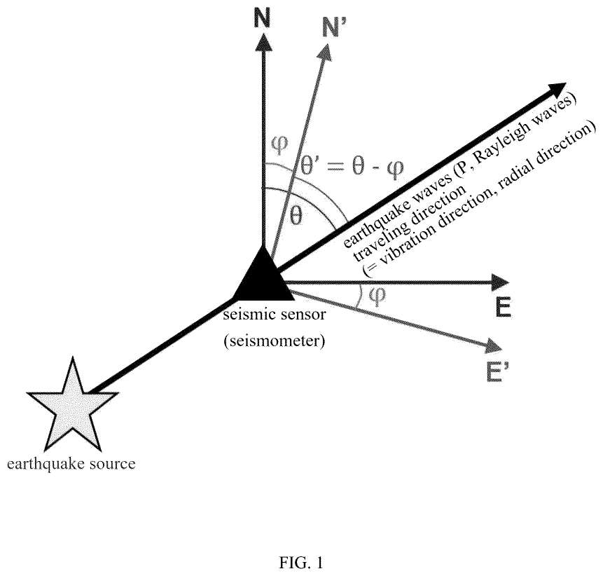

This is schematized as shown in FIG. 1. Here, the north and east sensor directions (N′, E′) of the seismometer are deviated by φ from the correct direction (N, E). Seismic waves propagate in the direction of azimuth θ, and the direction of polarization is horizontal to this. The azimuth θ′ of the apparent vibration direction (or apparent radial direction) that appears when this vibration direction is recorded on a seismograph is equal to θ−φ. The difference between the seismic wave path direction and the apparent vibration direction, i.e. θ−(θ−φ) indicates the direction φ in which the seismometer angle is distorted.

This analysis assumes that the actual radial direction is parallel to the great-circle path between the earthquake and the seismometer. However, earthquake location information contains a certain level of error, which is reflected in the calculation of the direction of the great-circle path. In addition, actual ground motion may propagate and vibrate in a direction different from the great-circle path due to the characteristics of various media in the Earth. These effects ultimately act as errors in estimating the seismometer orientation. In order to minimize these errors, it is necessary to improve the stability of the results by analyzing as many different earthquakes as possible. However, it takes a long time to accumulate enough data on earthquakes that are easy to analyze (i.e., strong earthquakes suitable to generate clean records). Therefore, this method is not easy to estimate the orientation of the seismometer immediately after the seismometer is installed.

Meanwhile, there is a method that utilizes microseism, a type of ambient noise that always exists, instead of seismic signals. Microseism is seismic wave energy generated when pressure perturbations caused by ocean waves stimulate the ocean floor. Microseism is an energy that exists almost all the time, and the advantage of using it is that there is no need to wait a long time for a specific signal to occur, as is the case when using earthquake waveforms, so continuous analysis and determination of the orientation of the seismometer are possible.

Microseism energy mainly consists of Rayleigh waves, and in the case of microseisms originating from a local or long distance, they form a plane wave with a locally horizontal radial direction. Therefore, if there is a seismometer (reference seismometer) whose installed direction is already known, the microseism radial direction in the area can be estimated by analyzing the waveforms from this seismometer. By comparing this actual microseism radial direction with the apparent radial direction shown in the seismometer to be analyzed (target seismometer), the corresponding seismometer orientation can be estimated.

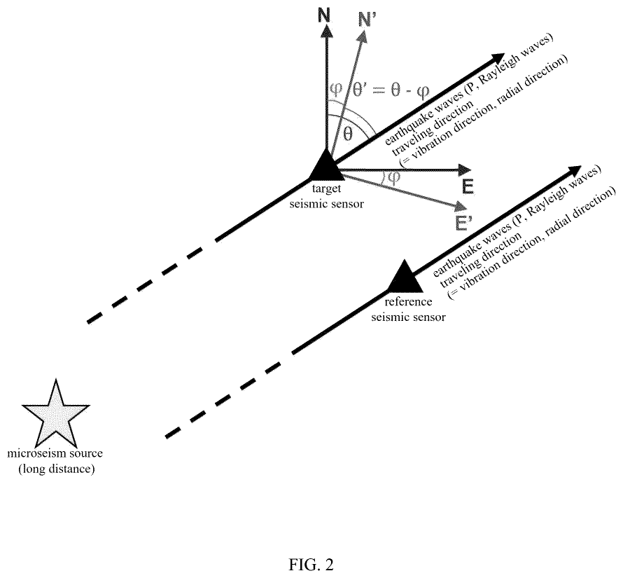

This is schematized as shown in FIG. 2. Here, a microseism source exists in the distance, generating plane waves within the local area where the target and reference seismometers are located. The actual traveling directions in the two seismometers are parallel, and this traveling direction (θ) can be determined through analysis of seismic waveforms in the reference seismometer. Meanwhile, the apparent radial direction (θ′) appearing in the target seismometer shows a difference from the actual radial direction by the angle (φ) at which the seismometer is distorted. Therefore, the orientation of the target seismometer can be determined from the difference between this apparent radial direction and the actual radial direction determined from the reference seismometer.

Compared to the method using seismic signals described above, this method using microseisms has the advantage of being free from seismic source location errors and analysis errors resulting from medium effects by utilizing the actually observed seismic wave traveling direction, in addition to the advantage of being able to be implemented at all times. On the other hand, analysis using microseisms presupposes the existence of a seismometer that can be used as a reference seismometer, that is, a local seismometer whose orientation is already known. Therefore, there is a limitation that it is difficult to apply when there is no seismometer with a known orientation in the area. As such, existing methods each have their own advantages and limitations, and there is a need to propose a new methodology that complements and integrates them.

Accordingly, the present disclosure aims at immediate and accurate seismometer determination through a converged methodology, and normalization of this process.

Hereinafter, the present disclosure will be described with reference to the drawings. For reference, the drawings may be partially exaggerated in order to explain the features of the present disclosure. In this case, it is preferable to be interpreted in light of the whole meaning of this specification.

The present disclosure analyzes both earthquake signals and microseism energy of ambient noise. The overall process consists of determining the seismometer orientation through each of the three methods, such as earthquake P-wave analysis, earthquake Rayleigh-wave analysis, and microseism analysis, then comparing and collecting them and calculating the final estimate.

First, for seismometers with a sufficient number of earthquake signals accumulated, the sensor orientation is determined through the P-wave and Rayleigh-wave from the earthquake, respectively. The seismometers whose orientations are determined here are selected as reference seismometers for microseism analysis. Next, analysis using microseism is performed. Through microseism analysis, orientations of all seismometers in an area can be determined. Finally, the reliability is evaluated by comparing the sensor orientation estimates of each seismometer determined through P-wave analysis, Rayleigh-wave analysis, and microseism analysis, and a representative estimate is determined and presented from the three estimates.

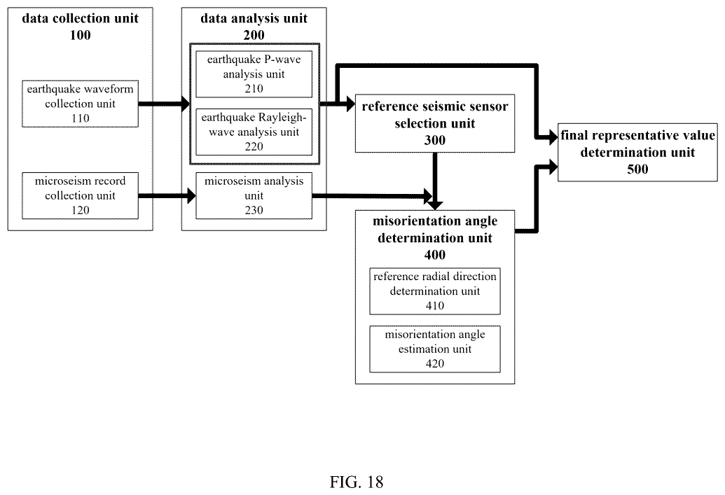

FIG. 18 shows a configuration diagram of a remote determination system of seismic sensor orientation according to the present disclosure.

The present disclosure is directed to a remote determination system of seismic sensor orientation, performed by a control server with database and operation functions, the system including a data collection unit 100, a data analysis unit 200, a reference seismic sensor selection unit 300, a misorientation angle determination unit 400, and a final representative value determination unit 500.

Specifically, the remote determination system of seismic sensor orientation using earthquake waveforms and microseism records according to the present disclosure includes: a data collection unit 100 that receives earthquake waveforms and microseism records; a data analysis unit 200 that analyzes earthquake P-waves and earthquake Rayleigh-waves of the earthquake waveforms input to the data collection unit 100 and analyzes microseism of the input microseism records; a reference seismic sensor selection unit 300 that selects a reference seismic sensor using analysis results derived from the data analysis unit 200; a misorientation angle determination unit 400 that determines a misorientation angle of a target seismic sensor, using an apparent radial direction determined through microseism analysis in the data analysis unit 200 and the reference seismic sensor selected in the reference seismic sensor selection unit 300; and a final representative value determination unit 500 that finally determines a representative seismic sensor orientation estimate, by collecting a seismic sensor orientation estimate calculated from the earthquake P-wave analysis of the data analysis unit 200, a seismic sensor orientation estimate calculated from the earthquake Rayleigh-wave analysis, and a seismic sensor misorientation angle determination value calculated from the misorientation angle determination unit 400.

Hereinafter, the data collection unit 100 according to the present disclosure will be described.

The data analysis unit 100 according to the present disclosure is provided with an earthquake waveform collection unit 110 and a microseism record collection unit 120, and can collect and receive earthquake waveforms and microseism records necessary for analysis.

The earthquake waveform collection unit 110 may collect three-component earthquake waveforms recorded in each seismic sensor for earthquake wave analysis, and the microseism record collection unit 120 may collect three-component continuous waveform data recorded in each seismic sensor for microseism analysis.

The earthquake waveform collection unit 110 collects three-component earthquake waveforms recorded in each seismic sensor. For stable analysis, a plurality of earthquake waveforms need to be collected. In addition, it is advisable to analyze the waveforms of large-scale earthquakes with a high signal-to-noise ratio. In addition, it is desirable to analyze earthquake data at various azimuths in order to minimize errors due to the effects of the propagation path medium.

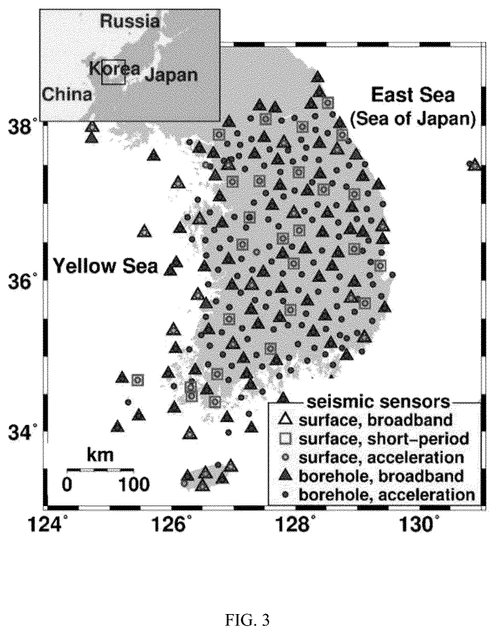

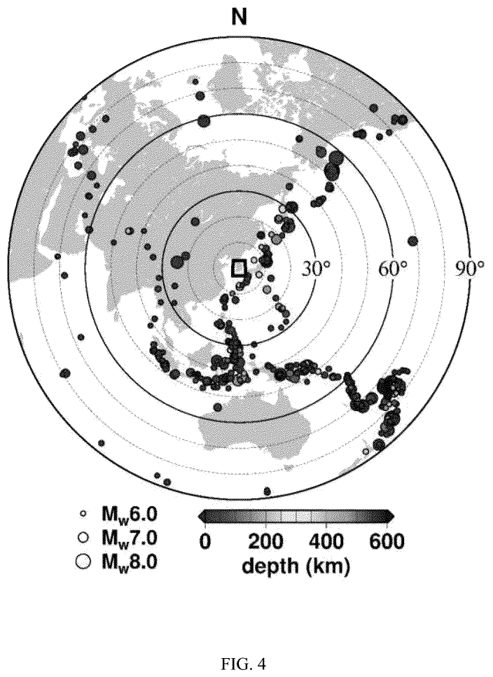

FIG. 3 shows the permanent earthquake observation network on the Korean Peninsula, as an example of seismometers subject to analysis. FIG. 4 shows the distribution of earthquakes used to estimate the orientation of the seismometers on the Korean Peninsula, as an example of earthquakes for analysis. In this example, earthquakes with a moment magnitude (Mw) of 6.0 or higher that occurred within an angular distance of 900 from the seismometer over the five years from 2018 to 2022 were used for analysis.

The microseism record collection unit 120 collects data for microseism analysis. Microseism is a type of ambient noise that is recorded continuously over a long period of time rather than appearing temporarily like seismic signals. Therefore, for microseism analysis, continuous waveform data is collected. It collects three-component continuous waveform data recorded from each seismometer during the period of time to be analyzed.

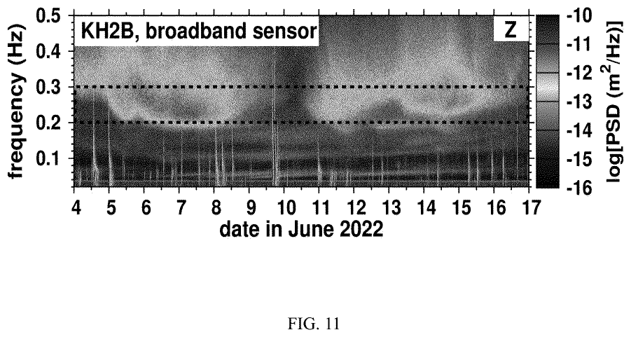

FIG. 11 is an example of the collected continuous waveform data, and shows a spectrogram of the vertical component continuous waveform recorded on the broadband seismic sensor at station KH2B for 13 days from June 4 to 16, 2022. It can be seen that strong secondary microseism is observed in the 0.2˜0.3 Hz frequency range. This microseism is used to estimate the seismic sensor orientation.

Hereinafter, the data analysis unit 200 according to the present disclosure will be described.

The data analysis unit 200 may analyze the earthquake P-wave and earthquake Rayleigh-wave of the earthquake waveforms input to the data collection unit 100, and analyze the microseism of the input microseism records.

The data analysis unit 200 includes an earthquake P-wave analysis unit 210 that performs polarization analysis on earthquake P-waves and estimates the seismic sensor orientation, an earthquake Rayleigh-wave analysis unit 220 that performs polarization analysis on earthquake Rayleigh-waves and estimates the seismic sensor orientation, and a microseism analysis unit 230 that performs polarization analysis on Rayleigh-waves included in microseism and determines the apparent orientation of the seismic sensor.

Hereinafter, the earthquake P-wave analysis unit 210 of the data analysis unit 200 will be described.

The earthquake P-wave analysis unit 210 performs polarization analysis on the earthquake P-wave and estimates the seismic sensor orientation from this. First, instrument effects included in the waveform is removed, and a time window is set for the P-wave. Here, it is desirable to ensure that the main energy component of the P-wave is well included. To this end, the time window can be set to sufficiently include waveforms before and after the theoretically expected P-wave arrival time. In addition, the waveform is bandpass filtered to an appropriate frequency band. In the low-frequency region to minimize local media effects, it is recommended to use a frequency band where a sufficient level of P-wave energy appears. In addition, the signal-to-noise ratio of the signal is measured, and waveforms with a signal-to-noise ratio below a preset level (for example, 2) are excluded from the analysis. Here, as the time window for the P-wave, the time window (for example, an 80-second time window from 30 seconds before to 50 seconds after the theoretical seismic wave arrival time for ak135, a one-dimensional Earth velocity model) of a preset section based on the theoretical P-wave arrival time is considered.

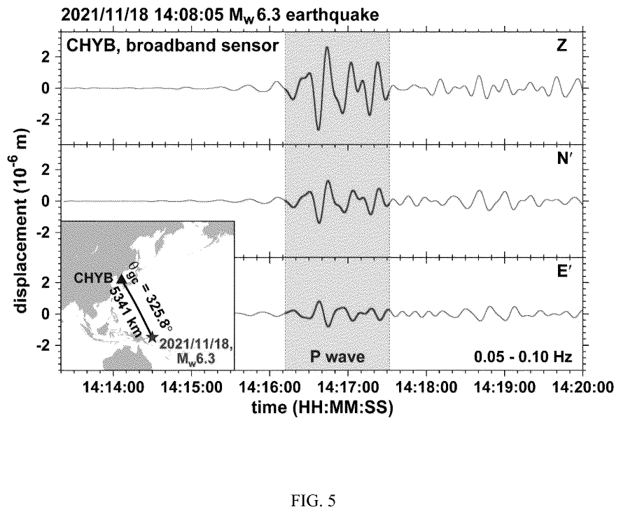

FIG. 5 is an example of the analyzed three-component P-wave waveform. Here, the waveform was bandpass filtered for the frequency band of 0.05-0.1 Hz.

Through analysis of the vibration direction of the three-component P-wave waveform, the radial direction of the seismic wave is determined. The radial direction can be determined from Equation 1 below.

$${θ}_{P} = {tan}^{- 1} [ \frac{{v}_{e}}{{v}_{n}} ] + ( sign ( η ) - 1 ) \times 90 ° \qquad [ Equation 1 ]$$

where θ_{P} is the radial direction of P waves, is the vₑ (East-West direction) component of the primary eigenvector, vₙ is the NS (North-South direction) component of the primary eigenvector, and η is the correlation coefficient of P waveforms between NS and vertical components. By comparing the observed apparent radial direction (θ′_{P}) with the great-circle path direction (θ_{gc}) from the earthquake to the station, the angle (misorientation angle) at which the direction in which the actual seismic sensor is placed deviates clockwise from the correct direction is estimated.

Here, the misorientation angle φ_{P} is given as in Equation 2 below.

$${φ}_{P} = \frac{1}{{N}_{e}} {\sum }_{i}^{{N}_{e}} [ {θ}_{gc} ( i ) - {θ}_{P} ( i ) ] \qquad [ Equation 2 ]$$

where Nₑ is the number of analyzed earthquakes, θ_{gc}(i) is the great-circle path direction from the i-th earthquake to the station, and θ_{P}(i) is the apparent radial direction of the P wave observed for the i-th earthquake.

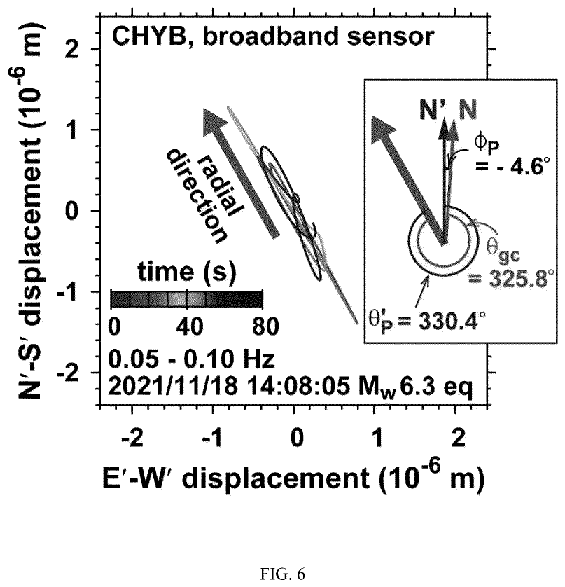

FIG. 6 is an example of analysis on one earthquake, and shows the apparent particle motion and the corresponding apparent radial direction (thick arrow) of the P WAVE of the 18 Nov. 2021 Mw 6.3 earthquake observed at the broadband sensor of station CHYB, and the sensor orientation (N′) (thin arrow) relative to due north (N) and the misorientation angle estimated through this. Here, the misorientation angle was determined to be −4.6°=355.4°.

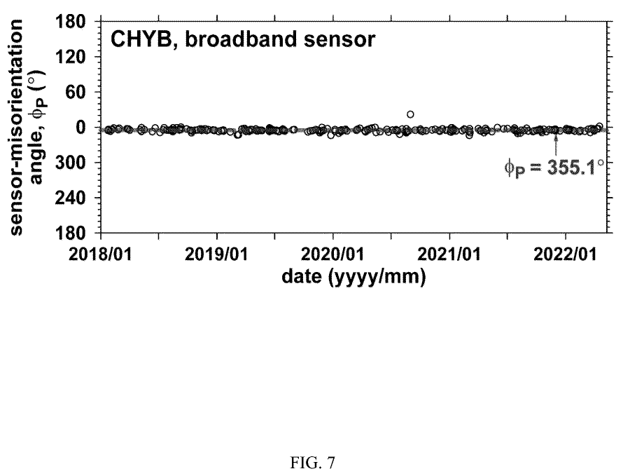

FIG. 7 shows the misorientation angle of the corresponding seismic sensor determined for a plurality of earthquakes (see FIG. 1), where the misorientation angles determined for each earthquake are arranged according to the time of earthquake occurrence. The misorientation angles determined using each earthquake match each other well. By averaging the values for all earthquakes, the misorientation angle is determined to be 355.1°. In addition, the standard error for the seismic sensor misorientation angle estimate can be investigated through statistical techniques such as bootstrap analysis for the earthquake set.

Hereinafter, the earthquake Rayleigh-wave analysis unit 220 of the data analysis unit 200 will be described.

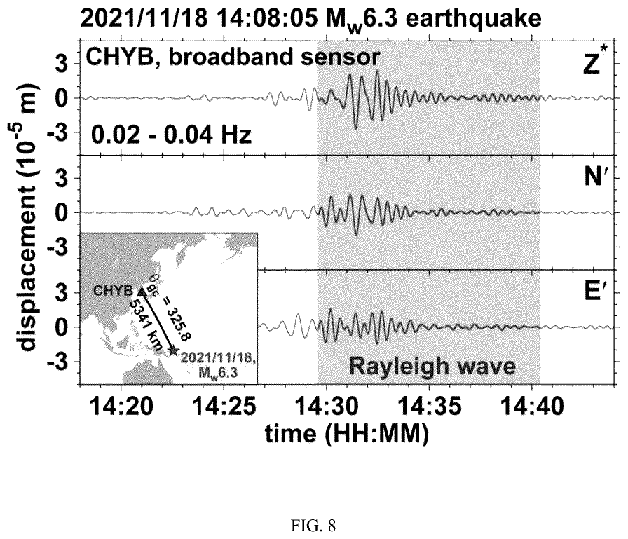

The earthquake Rayleigh-wave analysis unit 220 performs polarization analysis on the Rayleigh waves of the earthquake, and estimates the seismic sensor orientation through this. After removing instrument effects included in the waveform and band-pass filtering the waveform for a frequency band suitable for analysis, a time window is set in which major Rayleigh-wave energy components are observed and the waveform within the time window is analyzed. In the low-frequency region to minimize local media effects, it is recommended to use a frequency band in which a sufficient level of Rayleigh wave energy appears. In addition, the signal-to-noise ratio of the signal is measured, and waveforms with a signal-to-noise ratio below a preset level (for example, 2) are excluded from the analysis. Considering the group velocity (e.g., 4 km/s) of the preset Rayleigh waves at the corresponding frequency band, a preset time window (for example, a 650-second section spanning 50 seconds before and 600 seconds after the theoretical arrival time) based on the theoretical arrival time is considered as a time window. FIG. 8 is an example of the analyzed three-component Rayleigh-wave waveforms. Here, the analysis was performed for the frequency band 0.02-0.04 Hz.

By analyzing the vibration direction of the three-component Rayleigh-wave waveform, the radial direction of the earthquake wave is determined. The Rayleigh waves produce retrograde elliptical motions, which produces a 90°-phase difference between radial and vertical waveforms. Using these characteristics, the radial direction of the Rayleigh waves can be determined.

The horizontal component waveform rotated clockwise by a from the N (north) direction of the sensor is given by Equation 3 below.

$${u}_{h} ( α , t ) = cos ( α ) {u}_{n} ( t ) + sin ( α ) {u}_{e} ( t ) \qquad [ Equation 3 ]$$

where t is the time, uₕ(α, t) is the rotated horizontal component waveform, uₙ(t) and uₑ(t) are the north and east component waveforms, respectively.

The correlation coefficient C(α) between the 90° phase-shifted vertical waveforms u_{Z}*(t) and horizontal waveforms uₕ(α, t) is a function of the rotation angle α (directional correlation function) and is given in Equation 4 below.

$$C ( α ) = \frac{\int {u}_{z}^{*} ( t ) {u}_{h} ( α , t ) dt}{\sqrt{\int {[ {u}_{z}^{*} ( t ) ]}^{2} dt} \sqrt{{\int [ {u}_{h} ( α , t ) ) ]}^{2} dt}} \qquad [ Equation 4 ]$$

α, which maximizes the above correlation coefficient C(α), indicates the apparent radial direction of the Rayleigh wave. The difference angle between the great-circle path direction from the earthquake to the seismic sensor and the apparent radial direction of the Rayleigh wave indicates the seismic sensor misorientation.

When analyzing multiple earthquakes, the angle φ that maximizes the cumulative directional correlation function in Equation 5 is determined as the seismic sensor misorientation angle φ_{R}.

$$D ( φ ) = \frac{1}{{N}_{e}} {{\sum }_{i}}^{{N}_{e}} {C}_{i} [ {θ}_{gc} ( i ) - φ ] \qquad [ Equation 5 ]$$

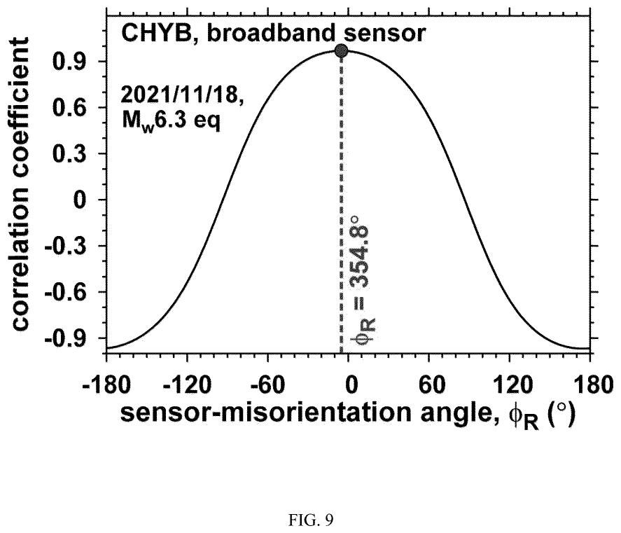

FIG. 9 is an example of analysis on one earthquake, and shows the directional correlation function and the determined misorientation angle (354.8°) for the Rayleigh wave of the 18 Nov. 2021 earthquake observed at the broadband sensor of station CHYB.

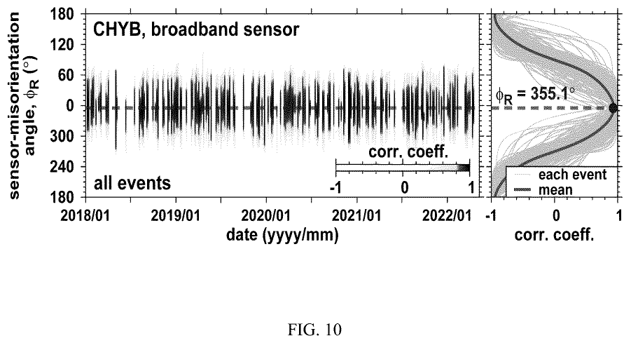

FIG. 10 shows a process of determining the corresponding seismic sensor orientation using a plurality of earthquakes. In the left graph, directional correlation functions for Rayleigh waves of each earthquake are presented according to the date of earthquake occurrence, and displayed in color. The right graph shows the cumulative directional correlation function for all earthquakes and the seismic sensor misorientation angle (355.1°) determined from it. The standard error for the seismic sensor misorientation estimate can be investigated through statistical techniques, such as bootstrap analysis, for the earthquake set.

Hereinafter, the microseism analysis unit 230 of the data analysis unit 200 will be described.

The microseism analysis unit 230 may perform polarization analysis on Rayleigh waves included in the microseism and determine the apparent orientation of the seismic sensor.

The microseism contains strong Rayleigh wave energy. Through analysis of the vibration direction of the three-component Rayleigh waveform, the apparent radial direction of the microseism Rayleigh wave is determined. The analysis on earthquake Rayleigh waves described above can be equally applied to continuous waveforms containing microseisms.

For stable analysis, filtering is applied to a preset analysis frequency range (e.g., 0.2-0.3 Hz) containing microseism energy. Considering that the microseism data is a continuous waveform, the continuous waveform is first divided into small time windows of a preset length (for example, 100 seconds) and the directional correlation function (C(α)) is independently determined in each time window. Afterwards, the directional correlation function is calculated for each waveform segment.

When the microseism source is fixed, the radial direction of the Rayleigh wave can be expected to remain unchanged. In this case, the stability of the analysis can be improved by superimposing the directional correlation functions determined for a plurality of waveform segments. The actual microseism source shows temporal changes along with temporal changes in ocean activity. In the present disclosure, the stability of the analysis is improved by superimposing the directional correlation function at each preset time interval (for example, 3 hours) and the temporal change in the radial direction is taken into consideration. The rotation angle α at which the maximum correlation coefficient appears for each time period indicates the apparent radial direction of the Rayleigh wave at that time.

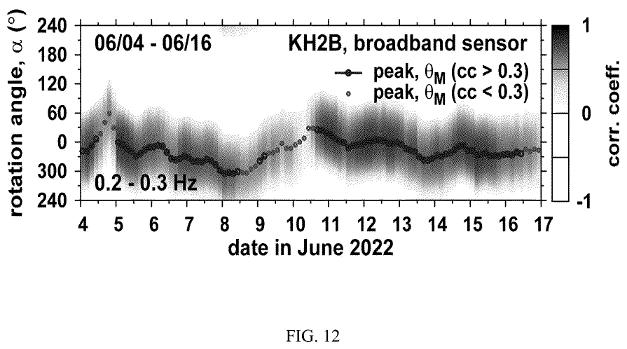

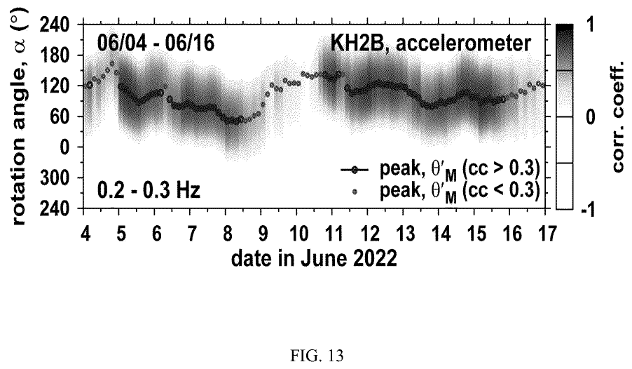

FIGS. 12 and 13 are examples of Rayleigh wave analysis in microseisms, showing the directional correlation function observed every 3 hours at the broadband seismic sensor and accelerometer of station KH2B, respectively, in color over time. The rotation angle α at which the maximum correlation coefficient appears in each time period indicates the apparent radial direction of the Rayleigh wave at that time. The apparent radial direction generally varies temporally with changes in the microseism source.

Through this process, apparent Rayleigh wave radial directions are determined at preset time intervals (e.g., 3 hours) in all seismic sensors. Here, the stability of the analysis can be judged based on the directional correlation coefficient for the apparent Rayleigh wave direction. The directional correlation coefficient is used to find the retrograde elliptical motion of Rayleigh waves, and appears higher when the ground particle motion caused by Rayleigh waves is clearer. When the directional correlation function is low, the Rayleigh wave component is not clearly observed, which means that the instability of the analysis is high. In order to remove unstable results from subsequent analysis, only results with a preset correlation coefficient level (e.g., 0.6) or higher are used in subsequent analysis.

Hereinafter, the reference seismic sensor selection unit 300 according to the present disclosure will be described.

The reference seismic sensor selection unit 300 according to the present disclosure may select a reference seismic sensor using the analysis results derived from the data analysis unit 200.

The reference seismic sensor selection unit 300 may select, as a reference seismic sensor, a seismic sensor whose reliability for an estimate meets a preset standard, among seismic sensors whose misorientation angles have previously been determined.

The preset reliability standard of the reference seismic sensor selection unit 300 includes at least one standard of a first standard where an error between the seismic sensor misorientation angles determined through mutually independent analysis is less than a preset angle, or a second standard where the standard error for the estimate is below a preset level.

When there is a seismic sensor whose installation direction is previously known, the reference seismic sensor selection unit 300 may determine the actual earthquake wave direction by correcting the apparent earthquake wave direction observed in the reference seismic sensor. This direction can be used as a reference value for comparison with the apparent earthquake wave direction observed in other seismic sensor. This is especially useful in determining the seismic sensor orientation through microseism analysis. A seismic sensor with a known installation direction is selected. When information on installation orientation is provided by seismic sensor operating agencies, such seismic sensors may be selected as reference seismic sensors. In addition, among seismic sensors whose misorientation angles have previously been determined through P-wave or Rayleigh-wave analysis, or any other method, those with sufficiently high reliability of the estimate can be considered as reference seismic sensors.

Here, as an example of a standard for determining the reliability of the misorientation angle estimate, considering the following conditions, when all or some of these conditions are met, it can be determined that the reliability is sufficient.

TABLE 1

| | |
|---|---|
| first | The error between the seismic sensor misorientation angles |
| condition | determined through independent analyses (e.g., P-wave |
| | analysis and Rayleigh-wave analysis) is less than a preset |
| | level (e.g., 3°). |
| second | The standard error for the estimate is below a preset level |
| condition | (e.g., 1.5°). |

When multiple misorientation angles are presented in one reference seismic sensor, the reference seismic sensor selection unit 300 may select the misorientation angle of the one reference seismic sensor using any one of a first decision method for determining the arithmetic mean value of the presented seismic sensor misorientation angles as a representative misorientation angle, a second decision method for determining the weighted average value of the presented seismic sensor misorientation angles as a representative misorientation angle, a third decision method for determining the median value of the presented seismic sensor misorientation angles as a representative misorientation angle, or a fourth decision method for determining a representative misorientation angle among the presented seismic sensor misorientation angles according to preset priorities.

In some cases, several different misorientation angles may be present in a single reference seismic sensor.

For example, for a single seismic sensor, several values for the seismic sensor misorientation angle may be presented, such as a direction provided by the operating agency, a direction based on P-wave analysis, a direction based on Rayleigh-wave analysis, or a direction estimated through other analyses.

In these cases, the representative misorientation angle for the reference seismic sensor can be determined through statistical techniques, including the determination methods below.

When n misorientation angles are presented for the reference seismic sensor as φ₁, φ₂, . . . , φₙ and the standard errors for these are equal to σ₁, σ₂, . . . , σₙ the representative misorientation angle for the reference seismic sensor can be determined through statistical techniques, including the following methods.

The first decision method concerns the arithmetic mean.

As shown in Equation 6 below, by averaging the given seismic sensor misorientation angles, this mean value may be selected as a representative value.

$${φ}^{0} = \frac{1}{n} {\sum }_{i = 1}^{n} {φ}_{i} \qquad [ Equation 6 ]$$

The second decision method concerns the weighted average.

As shown in Equation 7 below, by weighted average of the given seismic sensor misorientation angles considering the weight (ω₀, ω₁, . . . , ωₙ) for each value, the weighted average value may be selected as a representative value.

$${φ}^{0} = \frac{{\sum }_{i = 1}^{n} {ω}_{i} {φ}_{i}}{{\sum }_{i = 1}^{n} {ω}_{i}} \qquad [ Equation 7 ]$$

In particular, as one of the weight setting methods, the weight may be set in inverse proportion to the standard error for each value to determine the representative misorientation angle as shown in Equation 8 below.

$${φ}^{0} = \frac{{\sum }_{i = 1}^{n} \frac{{φ}_{i}}{{σ}_{i}}}{{\sum }_{i = 1}^{n} \frac{1}{{σ}_{i}}} \qquad [ Equation 8 ]$$

The third decision method concerns the median value.

The median value of the presented seismic sensor misorientation angles may be selected as a representative value. The median value refers to a value located in the middle when any given values are sorted in order of size.

The fourth decision method concerns priorities.

Considering the way the presented seismic sensor misorientation angles were determined, the highest priority misorientation angle estimate may be selected as a representative value, according to the preset priorities.

For example, priorities can be set as follows: orientation provided by seismic sensor operating agency (1st priority), orientation according to P-wave analysis (2nd priority), orientation according to Rayleigh-wave analysis (3rd priority).

Hereinafter, the misorientation angle determination unit 400 according to the present disclosure will be described.

The misorientation angle determination unit 400 may determine the misorientation angle of the target seismic sensor, using the apparent radial direction determined through microseism analysis in the data analysis unit 200, and the reference seismic sensor selected in the reference seismic sensor selection unit 300.

The misorientation angle determination unit 400 may include a reference radial direction determination unit 410 that determines the reference radial direction by correcting the seismic sensor misorientation angle from the apparent Rayleigh-wave radial direction observed in the reference seismic sensor, and a misorientation angle estimation unit 420 that estimates the misorientation angle of the target seismic sensor by comparing the apparent Rayleigh-wave radial direction observed in the target seismic sensor with the reference Rayleigh-wave radial direction observed in the reference seismic sensor at the same location.

The reference seismic sensor contains information about the seismic sensor orientation, along with the observed apparent Rayleigh wave direction. The reference radial direction is determined by correcting the seismic sensor misorientation angle from the apparent Rayleigh wave radial direction observed in the reference seismic sensor.

The misorientation angle of the target seismic sensor is estimated by comparing the apparent Rayleigh wave radial direction observed in the target seismic sensor with the reference Rayleigh wave radial direction observed in the reference seismic sensor at the same location. If there is no reference seismic sensor placed in the same location as the target seismic sensor, a reference seismic sensor at a local distance (within a preset distance from the target seismic sensor) is used. The misorientation angle of φ_{M} of the target seismic sensor is given by Equation 9 below.

$${φ}_{M} = {θ}_{M} - {θ}_{M}^{′} \qquad [ Equation 9 ]$$

where θ_{M} is the reference Rayleigh wave radial direction, and θ′_{M} is the apparent Rayleigh wave radial direction at the target seismic sensor.

Since the Rayleigh wave radial direction is determined at each preset time interval (for example, 3 hours), the misorientation angle φ_{M} is also determined at each corresponding time interval. A representative estimate can be determined by averaging all determined misorientation angle estimates. The standard error for a representative estimate can be determined through statistical techniques such as bootstrap analysis on the estimate.

Through this process, the misorientation angles of all seismic sensors can be determined, including seismic sensors for which the misorientation angles could not be determined based on earthquake data.

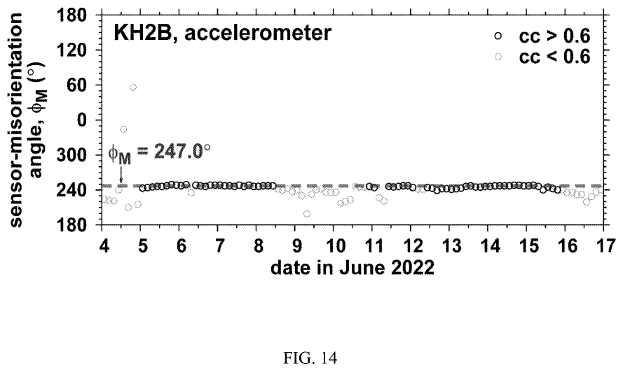

FIG. 14 is an example of seismic sensor orientation determination using microseism, and shows the result of determining the misorientation angle of the accelerometer at station KH2B. Here, as a reference seismic sensor, a broadband seismic sensor from the same station was used (see FIGS. 12 and 13). The misorientation angles of the seismic sensor determined every three hours are arranged according to time.

Hereinafter, the final representative value determination unit 500 according to the present disclosure will be described.

The final representative value determination unit 500 may determine a final representative value of a seismic sensor orientation, by collecting a seismic sensor orientation estimate calculated from the earthquake P-wave analysis of the data analysis unit 200, a seismic sensor orientation estimate calculated from the earthquake Rayleigh-wave analysis, and a seismic sensor misorientation angle determination value calculated from the misorientation angle determination unit 400.

The final representative value determination unit 500 may select the final representative value using any one of a first decision method for determining the arithmetic mean value of the three calculated seismic sensor misorientation angles as the final representative value, a second decision method for determining the weighted average value of the three calculated seismic sensor misorientation angles as the final representative value, a third decision method for determining the median value of the three calculated seismic sensor misorientation angles as the final representative value, or a fourth decision method for determining the final representative value among the three calculated seismic sensor misorientation angles, according to preset priorities.

The final representative value determination unit 500 collects the seismic sensor orientation estimates obtained from the three previously performed methods (earthquake P-wave analysis, earthquake Rayleigh-wave analysis, microseism analysis), and from these determines and presents the final representative value for the seismic sensor orientation. The seismic sensor misorientation angle estimates obtained from each analysis are collected and compared. Since each analysis was performed independently using different data and using different methodologies, if the estimates are consistent with each other, this supports the reliability of the results. Through this, the stability of the analysis results can be verified.

As a criterion for determining whether the estimates are consistent with each other, it may be considered whether the difference between them is less than a preset level (e.g., 2°).

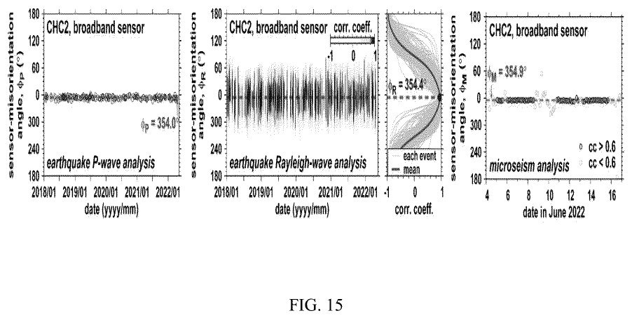

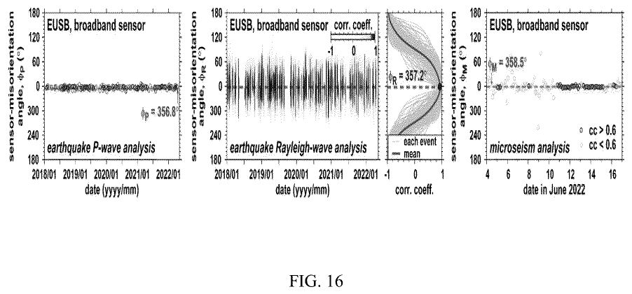

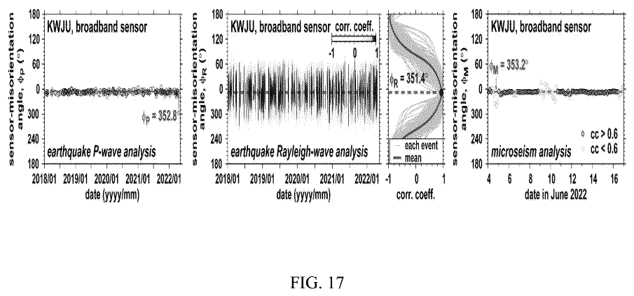

FIGS. 15, 16, and 17 are examples of comparisons of seismic sensor misorientation angle estimates determined from three methods, showing a comparison of the misorientation angles of broadband seismic sensors at stations CHC2, EUSB, and KWJU determined through the three analyses. For each seismic sensor, the seismic sensor misorientation angles determined through the three methods are similar to each other, showing a small difference of less than 2°. This supports the reliability of the results.

The seismic sensor orientation estimates obtained through the three methods described above can be combined through the following statistical method to determine one representative seismic sensor orientation estimate.

In addition, if necessary, additional seismic sensor orientation information (e.g. misorientation angle provided by seismic sensor operating agency) may be included to determine it.

For a given seismic sensor, when n misorientation angles such as φ₁, φ₂, . . . , φₙ are presented, and the standard errors for these are equal to σ₁, σ₂, . . . , σₙ a representative misorientation angle φ* and its standard error σ* for the seismic sensor can be determined through statistical techniques, including the following methods. Through this, representative values for the determined seismic sensor misorientation angles and their standard errors can be calculated. Through this, it is possible to provide reasonable and accurate estimation results for each seismic sensor orientation and information on their reliability.

The first decision method of the final representative value concerns the arithmetic mean.

As shown in Equation 6 below, the final representative value can be selected by averaging the given seismic sensor orientation estimates.

$${φ}^{0} = \frac{1}{n} {\sum }_{i = 1}^{n} {φ}_{i} \qquad [ Equation 6 ]$$

The second decision method of the final representative value concerns the weighted average.

As shown in Equation 7 below, by performing a weighted average of the given seismic sensor orientation estimates considering the weight (ω₀, ω₁, . . . , ωₙ for each value, the weighted average value may be selected as the final representative value.

$${φ}^{0} = \frac{{\sum }_{i = 1}^{n} {ω}_{i} {φ}_{i}}{{\sum }_{i = 1}^{n} {ω}_{i}} \qquad [ Equation 7 ]$$

In particular, as one of the weight setting methods, the weight may be set in inverse proportion to the standard error for each value to determine the final representative value as shown in Equation 8 below.

$${φ}^{0} = \frac{{\sum }_{i = 1}^{n} \frac{{φ}_{i}}{{σ}_{i}}}{{\sum }_{i = 1}^{n} \frac{1}{{σ}_{i}}} \qquad [ Equation 8 ]$$

The third decision method of the final representative value concerns the median value.

The median value of the presented seismic sensor orientation estimates may be selected as the final representative value. The median value refers to a value located in the middle when any given values are sorted in order of size.

The fourth decision method of the final representative value concerns priorities. Considering the way the presented seismic sensor orientation estimates were determined, the highest priority seismic sensor orientation estimate may be selected as the final representative value, according to the preset priorities.

For example, priorities can be set as follows: orientation provided by seismic sensor operating agency (1st priority), orientation according to P-wave analysis (2nd priority), orientation according to Rayleigh-wave analysis (3rd priority).

Meanwhile, the present disclosure can be implemented as a remote determination method of seismic sensor orientation. Specifically, it can be implemented as a remote determination method of seismic sensor orientation using earthquake waveforms and microseism records.

Although this method invention is different from the above-described system invention in terms of invention category, but is substantially the same in terms of technical configuration. Therefore, the technical configuration common to the system invention, and the following will focus on the gist of the present method invention.

According to another aspect of the present disclosure, there is provided a standardized remote determination method of seismic sensor orientation, performed by a control server with database and operation functions, the control server performing the steps of: a step S100 in which a data collection unit 100 receives earthquake waveforms and microseism records; a step S200 in which a data analysis unit 200 analyzes earthquake P-waves and earthquake Rayleigh-waves of the earthquake waveforms input to the data collection unit 100, and analyzes microseism of the input microseism records; a step S300 in which a reference seismic sensor selection unit 300 selects a reference seismic sensor using analysis results derived from the data analysis unit 200; a step S400 in which a misorientation angle determination unit 400 determines a misorientation angle of a target seismic sensor, using an apparent radial direction determined through microseism analysis in the data analysis unit 200 and the reference seismic sensor selected in the reference seismic sensor selection unit 300; and a step S500 in which a final representative value determination unit 500 determines a final representative value of a seismic sensor orientation, by collecting a seismic sensor orientation estimate calculated from the earthquake P-wave analysis of the data analysis unit 200, a seismic sensor orientation estimate calculated from the earthquake Rayleigh-wave analysis, and a seismic sensor misorientation angle determination value calculated from the misorientation angle determination unit 400.

In an embodiment, the step S200 may include: a step S210 in which an earthquake P-wave analysis unit 210 performs polarization analysis on earthquake P-wave and estimates the seismic sensor orientation, a step S220 in which an earthquake Rayleigh-wave analysis unit 220 performs polarization analysis on earthquake Rayleigh-waves and estimates the seismic sensor orientation, and a step S230 in which a microseism analysis unit 230 performs polarization analysis on Rayleigh-waves included in microseism and determines the apparent orientation of the seismic sensor.

In an embodiment, in the step S300, a seismic sensor whose reliability for an estimate meets a preset standard, among seismic sensors whose misorientation angles have previously been determined, may be selected as a reference seismic sensor.

In an embodiment, the step S400 may include: a step S410 in which a reference radial direction determination unit 410 determines the reference radial direction by correcting the seismic sensor misorientation angle from the apparent Rayleigh-wave radial direction observed in the reference seismic sensor, and a step S420 in which a misorientation angle estimation unit 420 estimates the misorientation angle of the target seismic sensor by comparing the apparent Rayleigh-wave radial direction observed in the target seismic sensor with the reference Rayleigh-wave radial direction observed in the reference seismic sensor at the same location.

In an embodiment, in the step S500, the final representative value may be selected using any of a first decision method for determining the arithmetic mean value of the three calculated seismic sensor misorientation angles as the final representative value, a second decision method for determining the weighted average value of the three calculated seismic sensor misorientation angles as the final representative value, a third decision method for determining the median value of the three calculated seismic sensor misorientation angles as the final representative value, or a fourth decision method for determining the final representative value among the three calculated seismic sensor misorientation angles, according to preset priorities.

In addition, the present disclosure may be implemented as a computer program. Specifically, the present disclosure may be implemented as a computer program stored in a computer-readable storage medium in order to execute the standardized remote determination method of seismic sensor orientation using earthquake waveforms and microseism records according to the present disclosure in conjunction with hardware by a computer.

Each of the methods according to the embodiments of the present disclosure may be implemented in the form of a program readable by various computer means and then recorded in a computer readable storage medium. In this case, the computer-readable storage medium may include program instructions, data files, and data structures solely or in combination. Program instructions recorded on the storage medium may have been specially designed and configured for the present disclosure, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. These hardware devices may be configured to operate as one or more software modules in order to perform the operation of the present disclosure, and the vice versa.

The embodiments described in the present specification and the accompanying drawings are merely illustrative of some of the technical spirit included in the present disclosure. Therefore, it is obvious that the embodiments disclosed in the present specification are not intended to limit the technical spirit of the present disclosure but is intended to describe the technical spirit, so that the scope of the technical spirit of the present disclosure is not limited by these embodiments. Modifications and specific embodiments that can be easily inferred by those skilled in the art without departing from the scope of the technical spirit included in the specification and drawings of the present disclosure should be interpreted as being included in the scope of the present disclosure.

What is claimed is:

1. A remote determination system of seismic sensor orientation using earthquake waveforms and microseism records, performed by a control server with database and operation functions, the system comprising:
a data collection unit that receives earthquake waveforms and microseism records;
a data analysis unit that analyzes earthquake P-waves and earthquake Rayleigh-waves of the earthquake waveforms input to the data collection unit and analyzes microseism of the input microseism records;
a reference seismic sensor selection unit that selects a reference seismic sensor using analysis results derived from the data analysis unit;
a misorientation angle determination unit that determines a misorientation angle of a target seismic sensor, using an apparent radial direction determined through microseism analysis in the data analysis unit and the reference seismic sensor selected in the reference seismic sensor selection unit; and
a final representative value determination unit that determines a final representative value of a seismic sensor orientation, by collecting a seismic sensor orientation estimate calculated from the earthquake P-wave analysis of the data analysis unit, a seismic sensor orientation estimate calculated from the earthquake Rayleigh-wave analysis, and a seismic sensor misorientation angle determination value calculated from the misorientation angle determination unit.

2. The remote determination system of seismic sensor orientation using earthquake waveforms and microseism records according to claim 1,
wherein the data collection unit collects three-component earthquake waveforms recorded in each seismic sensor for seismic wave analysis, and collects three-component continuous waveform data recorded in each seismic sensor for microseism analysis.

3. The remote determination system of seismic sensor orientation using earthquake waveforms and microseism records according to claim 1,
wherein the data analysis unit includes:
an earthquake P-wave analysis unit that performs polarization analysis on earthquake P-waves and estimates the seismic sensor orientation,
an earthquake Rayleigh-wave analysis unit that performs polarization analysis on earthquake Rayleigh-waves and estimates the seismic sensor orientation, and
a microseism analysis unit that performs polarization analysis on Rayleigh-waves included in microseism and determines the apparent direction of the seismic sensor.

4. The remote determination system of seismic sensor orientation using earthquake waveforms and microseism records according to claim 1,
wherein the reference seismic sensor selection unit selects, as a reference seismic sensor, a seismic sensor whose reliability for an estimate meets a preset standard, among seismic sensors whose misorientation angles have previously been determined.

5. The remote determination system of seismic sensor orientation using earthquake waveforms and microseism records according to claim 4,
wherein the preset reliability standard of the reference seismic sensor selection unit includes at least one standard of:
a first standard where an error between the seismic sensor misorientation angles determined through mutually independent analysis is less than a preset angle, or
a second standard where the standard error for the estimate is below a preset level.

6. The remote determination system of seismic sensor orientation using earthquake waveforms and microseism records according to claim 1,
wherein, when multiple misorientation angles are presented in one reference seismic sensor, the reference seismic sensor selection unit selects the misorientation angle of the one reference seismic sensor using any one of:
a first decision method for determining the arithmetic mean value of the presented seismic sensor misorientation angles as a representative misorientation angle,
a second decision method for determining the weighted average value of the presented seismic sensor misorientation angles as a representative misorientation angle,
a third decision method for determining the median value of the presented seismic sensor misorientation angles as a representative misorientation angle, or
a fourth decision method for determining a representative misorientation angle among the presented seismic sensor misorientation angles according to preset priorities.

7. The remote determination system of seismic sensor orientation using earthquake waveforms and microseism records according to claim 1,
wherein the misorientation angle determination unit includes:
a reference radial direction determination unit that determines the reference radial direction by correcting the seismic sensor misorientation angle from the apparent Rayleigh-wave radial direction observed in the reference seismic sensor, and
a misorientation angle estimation unit that estimates the misorientation angle of the target seismic sensor by comparing the apparent Rayleigh-wave radial direction observed in the target seismic sensor with the reference Rayleigh-wave radial direction observed in the reference seismic sensor at the same location.

8. The remote determination system of seismic sensor orientation using earthquake waveforms and microseism records according to claim 7,
wherein the misorientation angle estimation unit estimates the misorientation angle φ_{M} through Equation 9 below
$${φ}_{M} = {θ}_{M} - {θ}_{M}^{′} \qquad [ Equation 9 ]$$
where θ_{M} is the reference Rayleigh wave radial direction, and θ′_{M} is the apparent Rayleigh wave radial direction at the target seismic sensor.

9. The remote determination system of seismic sensor orientation using earthquake waveforms and microseism records according to claim 1,
wherein the final representative value determination unit selects the final representative value using any one of:
a first decision method for determining the arithmetic mean value of the three calculated seismic sensor misorientation angles as the final representative value,
a second decision method for determining the weighted average value of the three calculated seismic sensor misorientation angles as the final representative value,
a third decision method for determining the median value of the three calculated seismic sensor misorientation angles as the final representative value, or
a fourth decision method for determining the final representative value among the three calculated seismic sensor misorientation angles, according to preset priorities.

10. A remote determination method of seismic sensor orientation using earthquake waveforms and microseism records, performed by a control server with database and operation functions, the control server performing:
a step of receiving earthquake waveforms and microseism records input to a data collection unit;
a step of analyzing earthquake P-waves and earthquake Rayleigh-waves of the earthquake waveforms input to the data collection unit, and analyzing microseism of the received microseism records by a data analysis unit;
a step of selecting a reference seismic sensor using analysis results derived from the data analysis unit by a reference seismic sensor selection unit;
a step of determining a misorientation angle of a target seismic sensor, using an apparent radial direction determined through microseism analysis in the data analysis unit and the reference seismic sensor selected in the reference seismic sensor selection unit by a misorientation angle determination unit; and
a step of determining a final representative value of a seismic sensor orientation by a final representative value determination unit, by collecting a seismic sensor orientation estimate calculated from the earthquake P-wave analysis of the data analysis unit, a seismic sensor orientation estimate calculated from the earthquake Rayleigh-wave analysis, and a seismic sensor misorientation angle determination value calculated from the misorientation angle determination unit.

11. The remote determination method of seismic sensor orientation using earthquake waveforms and microseism records according to claim 10,
wherein the step of analyzing includes:
a step of performing polarization analysis on earthquake P-wave and estimating the seismic sensor orientation by an earthquake P-wave analysis unit,
a step of performing polarization analysis on earthquake Rayleigh-waves and estimating the seismic sensor orientation by an earthquake Rayleigh-wave analysis unit, and
a step of performing polarization analysis on Rayleigh-waves included in microseism and determining the apparent orientation of the seismic sensor by a microseism analysis unit.

12. The remote determination method of seismic sensor orientation using earthquake waveforms and microseism records according to claim 10,
wherein, in the step of selecting, a seismic sensor whose reliability for an estimate meets a preset standard, among seismic sensors whose misorientation angles have previously been determined, is selected as a reference seismic sensor.

13. The remote determination method of seismic sensor orientation using earthquake waveforms and microseism records according to claim 10,
wherein the step of the misorientation angle of a target seismic sensor includes:
a step of determining, by a reference radial direction determination unit, the reference radial direction by correcting the seismic sensor misorientation angle from the apparent Rayleigh-wave radial direction observed in the reference seismic sensor, and
a step of estimating, by a misorientation angle estimation unit the misorientation angle of the target seismic sensor by comparing the apparent Rayleigh-wave radial direction observed in the target seismic sensor with the reference Rayleigh-wave radial direction observed in the reference seismic sensor at the same location.

14. The remote determination method of seismic sensor orientation using earthquake waveforms and microseism records according to claim 10,
wherein, in the step of determining the final representative value of a seismic sensor orientation, the final representative value is selected using any of:
a first decision method for determining the arithmetic mean value of the three calculated seismic sensor misorientation angles as the final representative value,
a second decision method for determining the weighted average value of the three calculated seismic sensor misorientation angles as the final representative value,
a third decision method for determining the median value of the three calculated seismic sensor misorientation angles as the final representative value, or
a fourth decision method for determining the final representative value among the three calculated seismic sensor misorientation angles, according to preset priorities.

15. A computer program stored in a non-transitory computer-readable storage medium in order to execute the remote determination method of seismic sensor orientation using earthquake waveforms and microseism records according to claim 10 in conjunction with hardware by a computer.
